(19) United States
(12) Patent Application Publication
(10) Pub. No.: US 2011/0219046 A1
(43) Pub. Date: Sep. 8, 2011

(54) SYSTEM, METHOD AND COMPUTER PROGRAM PRODUCT FOR MANAGING DATA STORAGE AND RULE-DRIVEN COMMUNICATIONS FOR A PLURALITY OF TENANTS

(76) Inventors: Igor Nesmyanovich, Vaughan (CA); Vadym Faberovsky, Mississauga (CA)

(21) Appl. No.: 12/718,868

(22) Filed: Mar. 5, 2010

(51) Int. Cl. G06F 17/30

(52) U.S. Cl. 707/812; 707/E17.044; 707/E17.005

(57) ABSTRACT

The present invention is directed to storing and manipulating data and coordinating communications for a plurality of tenants within a single system. The system maintains a core schema containing common core objects and a plurality of pre-developed industry-specific schema templates. When a new tenant is added to the system, one of the industry-specific schema templates corresponding to the tenant's industry is cloned to generate a tenant schema for the new tenant. Once the tenant schema for the new tenant has been populated with data, communications to clients of that tenant may be generated according to universal communication rules and industry-specific communication rules applicable to that tenant, and optionally according to tenant-specific communication rules.

### FIELD OF THE INVENTION

The present invention is directed to systems for storing and manipulating data and coordinating communications, and more particularly to storing and manipulating data and coordinating rule-driven communications for multiple entities.

### BACKGROUND OF THE INVENTION

Rule-driven communication systems are generally known in the prior art. However, such prior-art systems as are known by the inventor hereof are either “off the shelf” systems with limited customizability for particular industries (or particular entities within particular industries), or else are bespoke systems either developed from scratch for a particular entity or created by way of costly code-level modification by the vendor of an off-the-shelf system.

### SUMMARY OF THE INVENTION

In one aspect, the present invention is directed to a method for receiving and storing data for multiple tenants in a single system. The method comprises the steps of maintaining, in a database system executing in memory by a processor of a computer, for a plurality of tenants, a plurality of translation maps, with each translation map corresponding to a particular tenant, and receiving, in the database system executing in memory by the processor of the computer, data sets from one of the tenants, with each data set comprising a plurality of data elements relating to a client of the one of the tenants. The method further comprises reorganizing, in a translation process executing in memory by the processor of the computer, the data elements into a common format according to the translation map for the one of the tenants. In the common format, each data element is identified as being one of a core data element and a tenant-related data element. The method further comprises storing the core data elements in at least one core table in the database system executing in memory by the processor of the computer, and storing the tenant-related data elements in at least one tenant-specific table in the database system executing in memory by the processor of the computer. The at least one core table is accessible by all tenants, and the at least one tenant-specific table is accessible only by the tenant with whom the tenant-related data elements originated. Each data element is uniquely associated with the one of the tenants from which it originated.

The method may further comprise generating tenant-specific, rule-driven communications to clients of the tenants by applying, in the database system executing in memory by the processor of the computer, communication rules to the data elements. The communication rules comprise at least industry-specific communication rules. The tenant-related data elements may comprise industry-specific data elements and tenant-specific data elements, and in the common format, each data element that is identified as a tenant-related data element may be further identified as being one of an industry-specific data element and a tenant-specific data element. The industry-specific communication rules may comprise generic industry-specific communication rules and tenant-mediated industry-specific communication rules, and the communication rules may further comprise universal communication rules and tenant-specific communication rules.

In another aspect, the present invention is directed to a method for initializing a data management system for a plurality of tenants. The method comprises maintaining, in a database system executing in memory by a processor of a computer, a core schema containing common core objects, maintaining, in the database system executing in memory by the processor of the computer, a plurality of pre-developed industry-specific schema templates in the database system, and, responsive to addition of a new tenant, selecting one of the industry-specific schema templates corresponding to an industry of the new tenant and cloning the selected industry-specific schema template to generate a tenant schema for the new tenant in the database system executing in memory by the processor of the computer.

In a further aspect, the present invention is directed to a method for managing tenant-specific, rule-driven communications for a plurality of tenants. The method comprises maintaining, in a database system executing in memory by a processor of a computer, client data relating to clients of a plurality of tenants, maintaining, in the database system executing in memory by the processor of the computer, a plurality of universal communication rules applicable to all tenants, maintaining, in the database system executing in memory by the processor of the computer, a plurality of industry-specific communication rules applicable only to tenants within a particular industry; and, for each tenant, generating, in the database system executing in memory by the processor of the computer, communications to clients of that tenant according to the universal communication rules and the industry-specific communication rules applicable to that tenant.

The industry-specific communication rules may comprise generic industry-specific communication rules and tenant-mediated industry-specific communication rules dependent on at least one variable determined by the respective tenant. The method may further comprise maintaining, in the database system executing in memory by the processor of the computer, a plurality of tenant-specific communication rules, each of the tenant-specific communication rules applicable to a specific one of the plurality of tenants and, for each tenant, generating, in the database system executing in memory by the processor of the computer, communications to clients of that tenant according to the tenant-specific communication rules applicable to that tenant.

In other aspects, the present invention is directed to computer program products comprising a machine readable storage medium having a machine readable program code embodied therein, the machine readable program code adapted to be executed to implement the above-described methods, and to data processing systems configured to implement the above-described methods.

### BRIEF DESCRIPTION OF THE DRAWINGS

These and other features of the invention will become more apparent from the following description in which reference is made to the appended drawings wherein:

FIG. 1 is a schematic representation of an overall data architecture according to an aspect of the present invention;

FIG. 2A is a schematic representation of an exemplary implementation of a system according to an aspect of the present invention, prior to provisioning for individual tenants;

FIG. 2B is a simplified schematic representation of the system of FIG. 2A, illustrating provisioning for individual tenants;

FIG. 2C is a schematic representation of the system of FIG. 2A in an exemplary configuration supporting two tenants following provisioning for those tenants;

FIG. 3 is a schematic representation of an exemplary table structure for storing information relating to clients of supported tenants, according to aspects of the present invention;

FIG. 4 is a schematic representation of an exemplary method for receiving and storing data for multiple tenants in a single system, according to an aspect of the present invention;

FIG. 5 is a flow chart showing an exemplary method for managing tenant-specific, rule-driven communications for a plurality of tenants, according to an aspect of the present invention; and

FIG. 6 is a block diagram illustrating an exemplary computer system in respect of which aspects of the present invention may be implemented.

### DETAILED DESCRIPTION

According to an aspect of the present invention, a single system is provided which can store and manipulate data and manage rule-driven communications for a plurality of tenants. The exemplary multi-tenant data architecture design taught herein provides a common core objects data structure across all tenants, and provides a replica of a vertical industry-specific objects data structure for each tenant in a particular predefined industry. Additionally, each tenant can have unique tenant-specific objects defining a tenant-specific objects data structure.

As used herein, the term “tenant” refers to a distinct entity for whom communications are managed. For example, a tenant could be a commercial enterprise, a non-profit organization, or a government agency. As such, a tenant may be an individual, a corporation, a partnership or other type of formal or informal group, or a sovereign such as a regional or national government or a subdivision thereof. Accordingly, where the term “client” is used herein, it is intended to have an expanded meaning encompassing not only commercial clients or “customers” of a tenant, but also any entity with whom a tenant's communications are to be managed. For example, where a tenant is a government agency, a client may be a person who is receiving government funds or services, or may be a taxpayer not receiving any specifically-directed services. Similarly, where a tenant is a non-profit organization, the clients of that tenant may be people receiving services from the non-profit organization, or they may be members of the non-profit organization, or persons who are not members but from whom contributions are to be solicited. In addition, tenants may have more than one type of client; e.g. a non-profit organization may have a first set of clients who receive services from the non-profit organization and a second set of clients who provide funds to the non-profit organization.

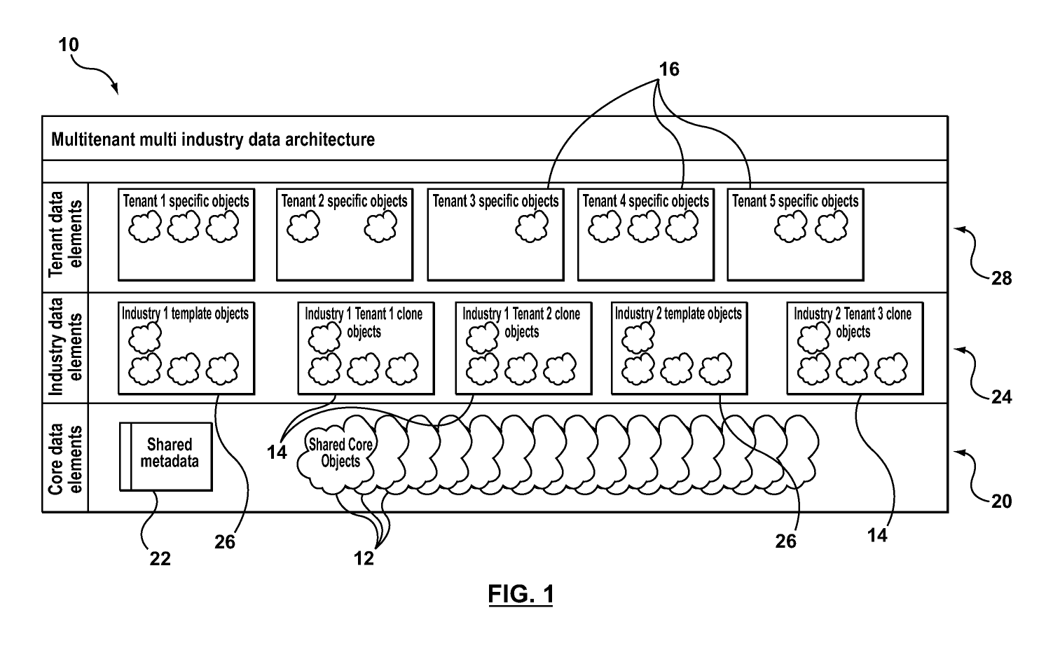

Systems according to aspects of the present invention utilize a single database, with a shared core schema and separate industry-specific schemas to facilitate management of data for multiple industries within a single system. With reference now to FIG. 1, a schematic representation of an overall data architecture according to an aspect of the present invention is shown generally at 10. The data architecture 10 comprises three primary types of objects: common core objects 12, industry-specific objects 14, and tenant-specific objects 16. In the illustrated embodiment, the common core objects 12, industry-specific objects 14 and tenant-specific objects 16 each contain respective attributes for common core data elements, industry-specific data elements, and tenant-specific data elements, according to an object-oriented architecture. Each of the industry-specific objects 14 and tenant-specific objects 16 can make use of the objects beneath it in the overall data architecture 10. Thus, tenant-specific objects 16 can make use of both common core objects 12 and industry-specific objects 14, and industry-specific objects 14 can make use of common core objects 12.

The common core objects 12 are those which have attributes for common core data elements, that is, data elements which will be common for all tenants across all industries, and define a first or foundation layer 20 for the overall data architecture 10. The foundation layer 20 also includes the shared core metadata 22 for the database. The common core data elements will typically encompass at least basic personal information about a tenant's clients, such as name and contact information. The common core objects 12 are shared among tenants in the sense that the data elements corresponding to the attributes of the core objects 12 are stored in a common format and all tenants will have access to the table or tables containing the data elements corresponding to the attributes of the common core objects 12; however as will be explained below tenants will only have access to their own data elements and not to the data elements of other tenants.

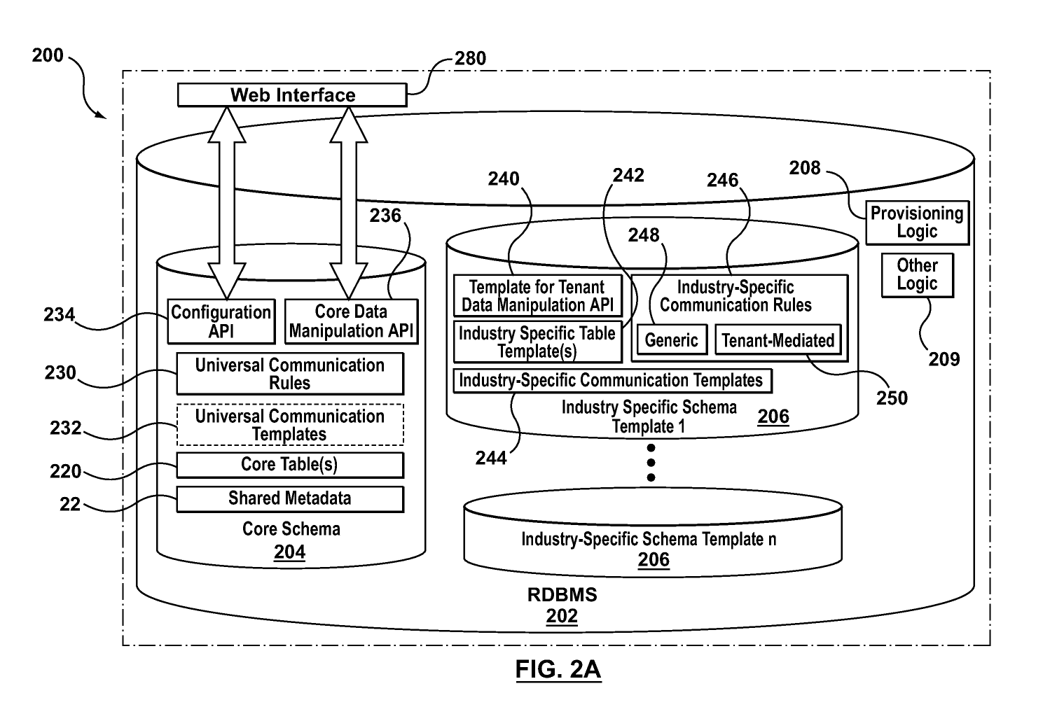

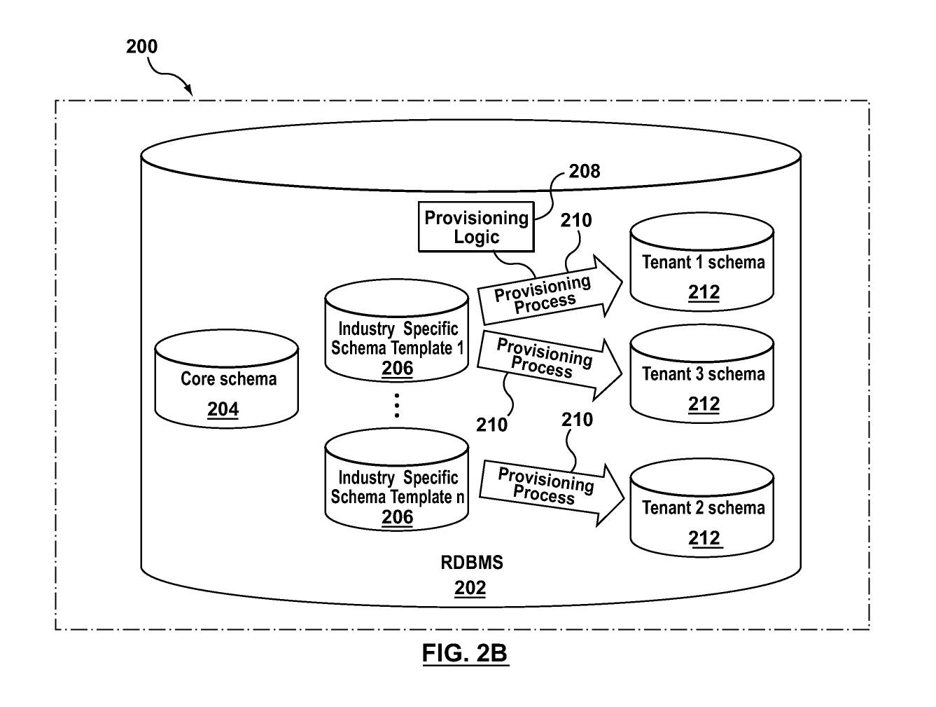

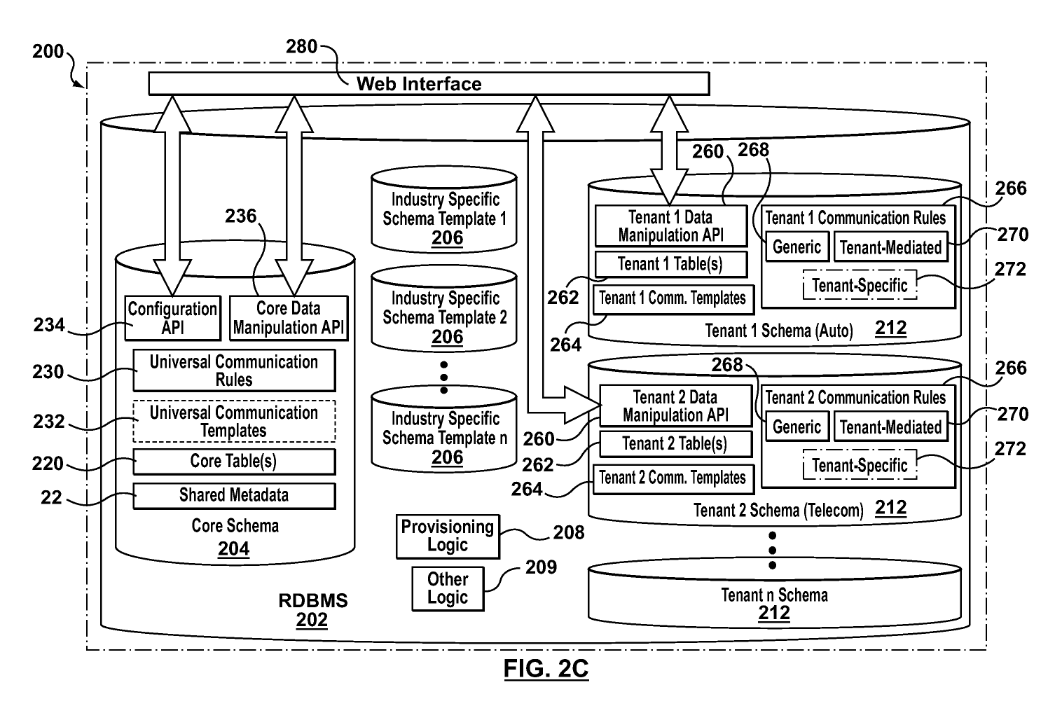

The industry-specific objects 14 are those which have attributes for contain industry-specific data elements, that is, those data elements which will be common for tenants within a given industry, and define a second layer 24 of the overall data architecture 10. As can be seen in FIG. 1, each tenant in a particular industry has its own industry-specific objects 14. The second layer 24 also includes a plurality of industry-specific template objects 26 which, for each industry, form part of a pre-developed industry-specific schema template 206 (see FIGS. 2A to 2C). The industry-specific template objects 26 are used to generate the industry-specific objects 14.

As used herein, the term “industry” refers to a type of operation which has certain characteristics that are common across all participants in operations of that type. For example, as will be discussed in greater detail below, all automotive providers (grouping together the manufacturers themselves as well as the authorized retail dealers who lease and sell to the public) will need to keep track of vehicle identification numbers and will require, or at least benefit from, management of communications relating to following up on new purchases or leases, regularly scheduled maintenance, product recalls, tire replacement, installation of winter tires, lease returns and other automobile-related communications. Thus, automobile manufacturing/dealing may be an industry. Similarly, all providers of telecommunication services (e.g. land-line phones, cable or satellite television, internet access, mobile phones, mobile e-mail devices) will typically all need to manage certain similar types of customer information, and will typically engage in periodic billing, periodic updating or modification of service plans, and may also wish to communicate special offers (e.g. providing a discount if a customer already receiving internet and cable television service from a single provider also subscribes to a wireless communication service from the same provider). Thus, telecommunications may be an industry, or subgroups thereof (e.g. internet service, television service, wireless communication) may each be an industry. Other examples of industries may include, without limitation, banking and financial services, insurance services or subcategories thereof (e.g. life, health, vehicle and home insurance), accounting services, medical and dental services, veterinary services, product supply and maintenance services of various types, and numerous others. Moreover, the term “industry” is not limited to commercial undertakings All non-profit groups which solicit contributions will need to communicate with their potential contributors, typically to solicit those contributions and inform them of the group's activities. In addition, certain types of government services may also be an industry.

The tenant-specific objects 16 are those which have attributes for tenant-specific data elements, that is, those data elements which are specific to a particular tenant and define a third layer 28 of the overall data architecture 10. Examples of tenant-specific data elements may include, without limitation, data elements relating to a loyalty program offered only by that tenant and data elements relating to product or service features that are exclusive to that particular tenant.

Referring now to FIG. 2A, an exemplary implementation of a system according to an aspect of the present invention, prior to provisioning for individual tenants, is shown generally at 200. In the exemplary system 200, a relational database management system (RDBMS) 202 is used. In the exemplary embodiment, the RDBMS is an RDBMS provided by Oracle Corporation, having an address at 500 Oracle Parkway, Redwood Shores, Calif. 94065, although other suitable RDBMS are also contemplated. The system 200 will of course include components other than the RDBMS 200, these are omitted for ease of illustration.

As shown in FIG. 2A, the RDBMS 202 includes a core schema 204 which contains the common core objects 12 (FIG. 1) that are common for the whole system 200, as well as the shared metadata 22. The RDBMS 202 also comprises a plurality of pre-developed, industry-specific schema templates 206 which are used as vertical industry-specific templates for provisioning individual tenants, that is, for generating the industry-specific objects 14 (FIG. 1). Each industry-specific schema template 206 comprises a set of industry-specific template objects 26 (FIG. 1) as well as procedures grouped into template schemas. As shown in FIG. 2A, the system may have from one to n industry-specific schema templates 206. Preferably, in order to take advantage of the benefits provided by an architecture according to an aspect of the present invention, a system will have at least two industry-specific schema templates 206. The RDBMS 202 also includes provisioning logic 208, as well as other logic 209 as is known in the art.

The core schema 204 includes one or more core tables 220, which contain the common core data elements, that is, the data elements corresponding to attributes of the common core objects 12 (FIG. 1). In addition, the core schema 202 includes universal communication rules 230 and optionally universal communication templates 232, as well as a configuration API (Application Programming Interface) 234 and a core data manipulation API 236.

Each industry-specific schema template 206 includes a template 240 for a tenant data manipulation API, industry specific table templates 242, industry-specific communication templates 244, and industry-specific communication rules 246, which include both generic industry-specific communication rules 248 and tenant-mediated industry-specific communication rules 250, as discussed in greater detail below.

Referring now to FIG. 2B, when a new tenant is added to the system 200, a provisioning process 210 generates a clone of the relevant industry-specific schema template 206 for that tenant, resulting in a tenant schema 212 for that tenant having precisely the same data structure as the industry-specific schema template 206 together with the corresponding procedures. In a currently preferred embodiment, provisioning for a new tenant is manually initiated according to the following process. An administrator for the system 200 selects an industry-specific schema template 206 corresponding to the new tenant's industry, and initiates a cloning process, which generates the tenant schema 212 for the new tenant. The tenant schema 212 for the new tenant is an exact replica of the metadata configuration of the industry-specific schema template 206. After the cloning process is completed, an administrator for the tenant may modify the tenant schema 212, as will be explained in greater detail below. Alternatively, an automated process may be used; for example the new tenant may select their industry.

FIG. 2C shows the system 200 in an exemplary configuration in which provisioning has been completed for n tenants, including Tenant 1, which is an automotive company, and Tenant 2, which is a telecommunications company. Thus, each tenant has a respective tenant schema 212, which is a clone of the relevant industry-specific schema template 206. Accordingly, each tenant schema 212 includes a tenant data manipulation API 260, one or more tenant tables 262, one or more tenant communication templates 264, and industry-specific communication rules 266, which include both generic industry-specific rules 268 and tenant-mediated industry-specific rules 270, as well as any tenant-specific rules 272 added by the tenant as discussed below.

Within the RDBMS 202, each tenant's objects are logically separated from other tenants' objects, with the data elements corresponding to the attributes of the common core objects 12 (FIG. 1) being stored in the core table(s) 220 accessed by all tenants, and the data elements corresponding to the attributes of the industry-specific objects 14 and the tenant-specific objects 16 being stored in the tenant tables 262 accessible only by the tenant with whom that tenant table 262 is associated.

Each object's attributes are classified as either core attributes or tenant-related attributes. More particularly, core attributes are attributes associated with the common core objects 12, and tenant-related attributes are the attributes associated with the industry-specific objects 14 and the tenant-specific objects 16. The attributes of the industry-specific objects 14 and tenant-specific objects 16 are grouped together as tenant-related attributes in terms of classification because they are treated similarly, and differently from the core attributes. Each core table 220 contains data elements corresponding to core attributes, that is, attributes of common core objects 12, for all tenants, although logically separated by tenant. Each tenant table 262 contains tenant-related attributes, that is, attributes of the industry-specific objects 14 and any tenant-specific objects 16, for only a single tenant. Optionally, there may be variations in handling as between industry-specific attributes, that is, attributes of industry-specific objects 14, and tenant-specific attributes, that is, attributes of tenant-specific objects 16.

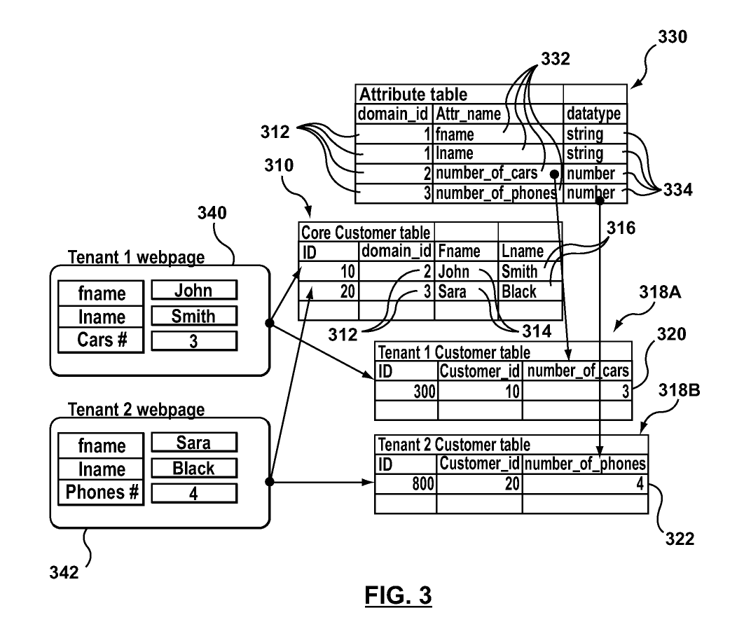

FIG. 3 illustrates schematically an exemplary table structure for storing customer information, that is, information relating to customers (clients) of the tenants, according to aspects of the present invention. Common core data elements, that is, data elements corresponding to attributes of the common core objects 12 (FIG. 1), relating to individual customers (clients), are stored in a core table 220, such as the exemplary core customer table 310. Each tuple in the core customer table 310 has a “domain_id” attribute 312, which uniquely identifies each tenant and enables logical separation of tenants. This permits each common core data element to be virtually isolated to the tenant with whom it is associated for security purposes, while being stored in a common table. In particular embodiments, the core tables 220 containing data elements corresponding to the attributes of common core objects 12 for all tenants may grow to a very large size, and for scaling purposes may be physically partitioned, for example by the attribute “domain_id” discussed below.

The exemplary core customer table 310 includes generic common core data elements “Fname” 314 and “Lname” 316 corresponding to a customer's first and last names, respectively. The tenant-related attributes, that is, the attributes of the industry-specific objects 14 and of any tenant-specific objects 16, relating to individual customers are stored in tenant-specific tenant tables 262, in this case an exemplary first tenant customer table 318A for Tenant 1, which is an automotive company, and a second tenant customer table 318B for Tenant 2, which is a telecommunications company. The tenant customer table 318A for Tenant 1 includes data elements 320 corresponding to the industry-specific attribute “number_of_cars” and the tenant customer table 318B for Tenant 2 includes data elements 322 corresponding to the industry-specific attribute “number_of_phones”. A single metadata attribute information table 330, which is part of the shared metadata 22 (FIGS. 1, 2A and 2C) stores information about each tenant data model, logically separated by the domain_id attribute 312.

In particular example shown in FIG. 3, in the exemplary metadata attribute information table 330, a value of “1” for the domain_id attribute 312 denotes a core attribute (common core data element 12), while the value “2” denotes a tenant-related attribute (e.g. industry-specific data element 14) corresponding to Tenant 1, and the value “3” denotes a tenant-related attribute (e.g. industry-specific data element 14) corresponding to Tenant 2. Although only the domain_id 312, attribute name 332 and data type 334 are shown in the exemplary metadata attribute table 330 for ease of illustration, one skilled in the art, now informed by the herein disclosure, will appreciate that a metadata attribute information table in accordance with an aspect of the present invention will contain information about all data elements, its data types, relationship between hierarchy levels, storage attributes, security access etc. Thus, the shared core metadata 22 (FIGS. 1, 2A and 2C) keeps all logical associations between tenants and their objects and maintains secure separation of the data elements corresponding to each tenant.

The hierarchy of objects, that is, the distinctions in storage and handling between common core objects 12, industry-specific objects 14 and any tenant-specific objects 16 is invisible to tenant users; from their point of view all data elements are located in one database. As can be seen in FIGS. 2A, 2C and 3, in a preferred embodiment tenants are provided with web-based access to the system 200. In particular, operators at Tenant 1 are provided with a first web interface front-end 340, and operators at Tenant 2 are provided with a second web interface front-end 342, which presents data from the exemplary core customer table 310 and from the first tenant-specific customer table 318A and the second tenant-specific customer table 318B, respectively, in a single integrated display. Tenants do not access data in the tenant-specific customer tables or the core tables directly. Instead, a set of methods is used to maintain proper data manipulation and security, so that each tenant has access only to its own data and is restricted from accessing other tenants' data. As such, through the web interface 280 (FIGS. 2A and 2C) a tenant operator can add and modify data using the core data manipulation API 236 in the core schema 204 (FIGS. 2A and 2C) as well as their respective tenant data manipulation API 260. Presentation in the web interface 280 will be unified, as shown in the exemplary web interface front-ends 340, 342, so that the tenant operator merely enters the desired new data or data modification, and either the core data manipulation API 236 or the respective tenant data manipulation API 260, or both, will handle the data updating. Each tenant's data can be modified independently from that of any other tenants because the system 200 uses metadata to support a dedicated set of tenant-specific tables 262 for each tenant. This model does not require separate tracking of tables and data elements' data extensions; data for a tenant level object is distributed across common core objects 12, industry-specific objects 14 and possibly tenant-specific objects 16 (FIG. 1).

Even within the same industry, different tenants may have different unique needs, depending upon the details of their operation. Therefore, aspects of the present invention provide for extension of a tenant's tenant schema 212 (which as noted above is a clone of the industry-specific schema template 206) to more effectively meet that particular tenant's needs, without affecting the data model (the industry-specific schema template 206) as used by other tenants. Thus, once provisioned, tenants may add and modify object attributes and methods and add new methods, and also add new classes (types of objects) in their own tenant schema 212 at any time without affecting the tenant schemas 212 of other tenants. The web-based interface 280 (FIGS. 2A and 2C) may be provided to enable the tenant administrator to make these changes via the configuration API 234, with suitable security protocols imposed so as to limit each tenant's administrator(s) to modifying only that tenant's tenant schema 212.

The modification of attributes may include modification of the List of Values for attributes, data types, associations between attributes and application tasks (pages, programs, campaigns, business classes, etc.). If a tenant wishes to not only add or modify attributes but also wishes to add or modify data manipulation methods, the tenant administrator can modify existing methods within that tenant's tenant schema 212, i.e. change and then recompile the existing code for that tenant's template schema 212, and can create new methods which will provide functionality that is not present in the industry-specific schema template 206 and hence was not present in that tenant's tenant schema 212 as originally cloned.

The tenant administrator may define new classes or change the hierarchy of existing classes. Where a tenant administrator is defining new classes, he or she will also need to define the attributes for those classes, and a class metadata management tool is provided for this purpose, accessible through the web interface 280. The tenant administrator will also need to create methods for each new class and implement these new methods in the RDBMS internal procedural languages (e.g. Oracle), and can change the execute permissions for existing methods or change the rules defined for existing methods and workspaces. In particular, through the web interface 280, the tenant administrator is able to make use of the configuration API 234 to make these changes.

When the tenant administrator is creating an extended attribute (e.g. using the web interface 280 and configuration API 234), the system 200 creates a new record in the metadata attribute table 330 (FIG. 3), identified by the tenant domain_id attribute and also adds a new column to the object extension table in the tenant schema 212 (FIG. 2C). When a tenant administrator creates a new attribute using the web interface and specifies the properties of the new attribute, including data type, then the system 200 automatically determines how to process a new request to extend attributes and uses metadata to identify the appropriate storage table and validate it against the required data type, and then updates the appropriate tenant table(s). The configuration API 234 automates implementation of these changes and facilitates use of the extended attributes to be used by connected applications and to make these changes automatically.

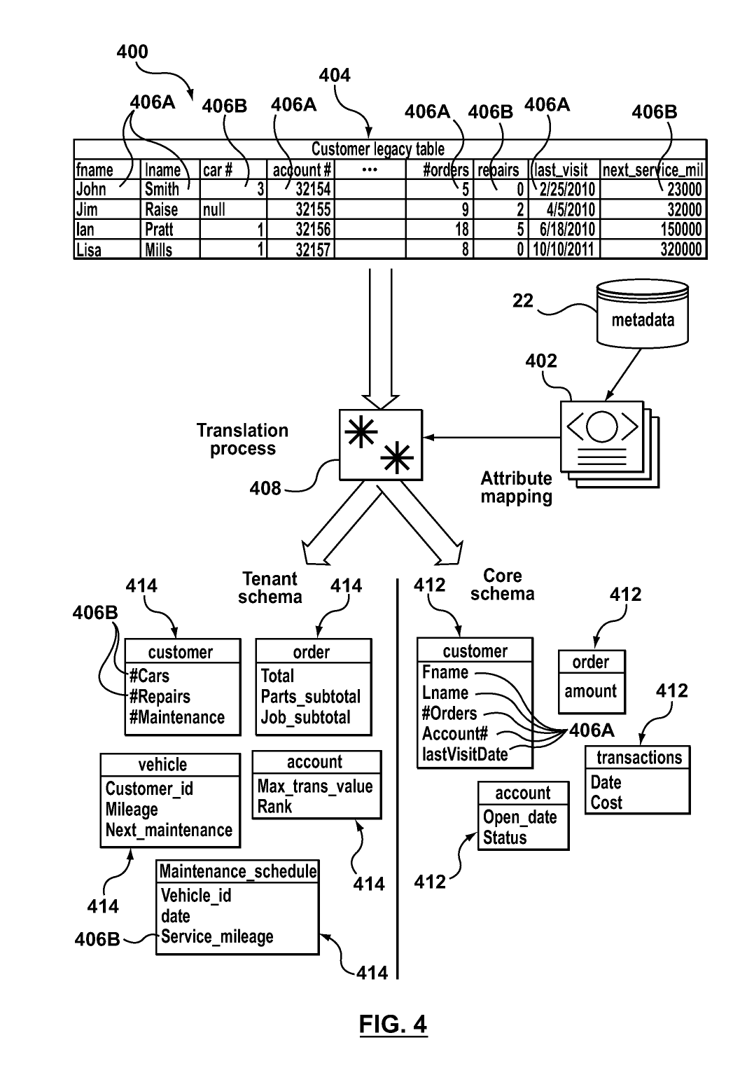

Reference is now made to FIG. 4, which illustrates schematically an exemplary method 400 for receiving and storing data for multiple tenants in a single system, such as the system 200 (FIGS. 2A to 2C). The method 400 maintains, for a plurality of tenants, a plurality of translation maps 402, which use the shared metadata 22 (see also FIG. 1). Each translation map 402 corresponds to a particular tenant. A system (e.g. the system 200 shown in FIGS. 2A to 2C) implementing the method 400 receives data sets, such as the legacy table 404, from one of the tenants. The legacy table 404 represents data according to the tenant's proprietary data format, and the translation map 402 corresponding to that tenant maps the tenant's proprietary data format to a common format used by the system (e.g. system 200) which receives the legacy table 404. As can be seen in FIG. 4, each data set, such as the legacy table 404, comprises a plurality of data elements 406A, 406B relating to a client of the tenant from whom the data set originated. A translation process 408 reorganizes the data elements 406A, 406B according to the translation map 402 for that tenant into a common format in which each data element 406A, 406B is identified as being one of a core data element 406A and a tenant-related data element 406B. The core data elements 406A are then stored in at least one core table 412 that is accessible by all tenants, and the tenant-related data elements 406B are stored in at least one tenant-specific table 414 that is accessible only by the tenant with whom the tenant-related data elements originated. As shown in FIG. 3, each data element 406A, 406B is uniquely associated with the tenant from which it originated, such as by way of the domain_id attribute.

Aspects of the present invention provide for application of rule-based data processing and automated decision-making to manage communications and client interactions. These rules fall within one of three categories: universal communication rules that are common to all industries and hence to all tenants, industry-specific communication rules that are common across an industry but not common to all industries, and tenant-specific communication rules.

One example of a possible universal communication rule is to send a welcome communication to all new clients. Another example of a universal communication rule is to permit the system to send commercial communications to a tenant's client only if the client has provided affirmative opt-in consent prior to sending the communication. Optionally, universal communication rules may be tenant-mediated; that is, the rules may be tuned by or for particular tenants, for example by modifying certain variables in the rules. Thus, there can be generic universal communication rules and tenant-mediated universal communication rules.

Within the category of industry-specific communication rules, there are generic industry-specific communication rules and tenant-mediated industry-specific communication rules. Generic industry-specific rules are those applied across an entire industry regardless of the tenant. In the automotive industry, an example of a possible generic industry-specific communication rule is to send a reminder at a predetermined date (e.g. November 1) to have winter tires installed; such a rule is independent of the particular automotive tenant. Another example of a universal communication rule in the automotive context is a rule that a vehicle recall notification message requires a delivery confirmation. In contrast, a tenant-mediated industry-specific communication rule is a rule which is specific to the industry but contains one or more variables which are determined or set by the tenant or by characteristics related to the tenant, and is pre-defined for the relevant industry. An example of a possible tenant-mediated industry-specific communication rule in the automotive industry at is to send a reminder to clients about scheduled maintenance every X days or months, with X being specified by the tenant since it will depend on the maintenance schedule of the particular automobile.

A tenant-specific communication rule is a rule which is specific to a tenant and not pre-defined for application to the relevant industry standard schema generally. As such, a tenant-specific communication rule may or may not be related to the tenant's industry. One possible example of a tenant-specific communication rule is to send a birthday greeting (possibly containing a promotional offer) to each client on or shortly before their birthday; this rule has no relation to the tenant's industry. Another example is that a particular automotive tenant may wish to send a promotional award to customers who have driven more than 250,000 miles in a single vehicle where such communications are not supported by any tenant-mediated industry-specific communication rule; although such a rule relates to the industry it is still tenant-specific because it is defined by the tenant rather than in advance for the industry generally.

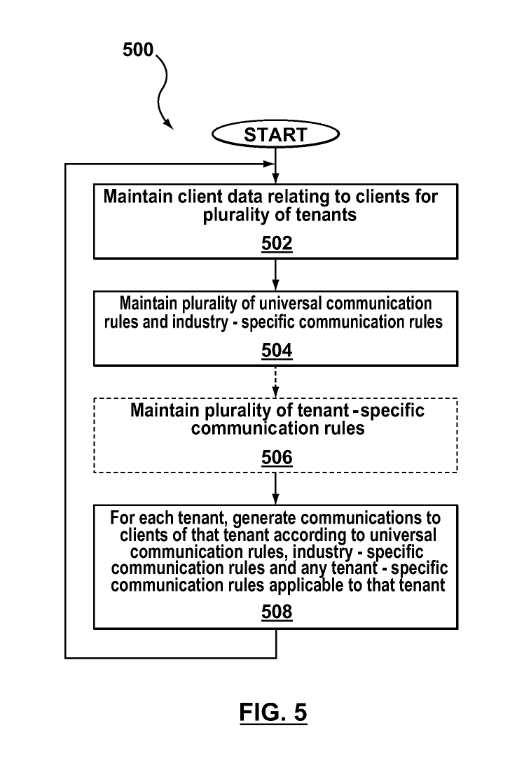

With reference now to FIG. 5, an exemplary method for managing tenant-specific, rule-driven communications for a plurality of tenants according to an aspect of the present invention is shown generally at 500. The method 500 may be executed in any suitable data processing system. At step 502, the method 500 maintains client data relating to clients of a plurality of tenants, for example by way of the exemplary methods described above. At step 504, the method 500 maintains a plurality of universal communication rules applicable to all tenants and a plurality of industry-specific communication rules applicable only to tenants within a particular industry. As noted above, the universal communication rules may comprise generic universal communication rules and tenant-mediated universal communication rules, and the industry-specific communication rules may comprise generic industry-specific communication rules and tenant-mediated industry-specific communication rules dependent on at least one variable determined by the respective tenant. At optional step 506, the method 500 maintains a plurality of tenant-specific communication rules, with each of the tenant-specific communication rules being applicable to a specific one of the plurality of tenants. The above described steps 502 and 504 and optional step 506 may be performed in any suitable order, and the term “maintain” includes such maintenance activities as updating the data and rules to reflect changes thereto.

At step 508, for each tenant the method 500 generates communications to clients of that tenant according to the universal communication rules and the industry-specific communication rules applicable to that tenant, as well as according to any tenant-specific communication rules applicable to that tenant. Typically, the content of the communications generated at step 508 will come from the tenant communication templates 264, as well as any universal communications templates 232. The communications generated at step 508 may take any suitable form, including without limitation electronic mail, text messaging to a wireless communication device, paper-based communications (e.g. mail), facsimile communications, automated telephone communications, as well as human-mediated communications such as from a call center. Generating the communication will generally comprise sending an instruction including the content of the communication to another system, which will effect transmission of the communication.

The above-described approach supports reuse of data rules and data manipulation code, thereby providing enhanced efficiency and simplicity of operation, while at the same time providing flexibility to satisfy the communication needs of particular tenants.

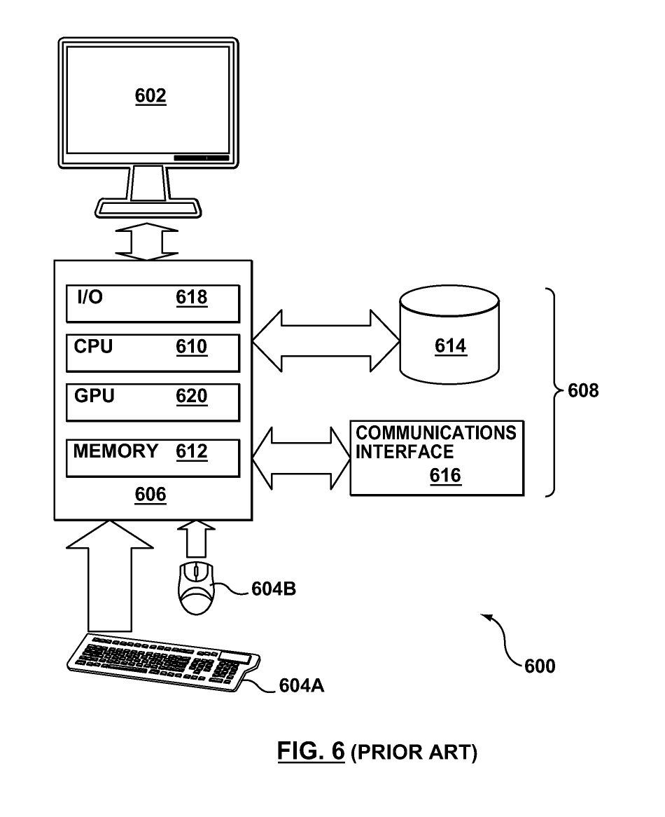

Aspects of the present invention may be implemented on any suitable computer or microprocessor-based system. An illustrative computer system in respect of which aspects of the present invention may be implemented, is presented as a block diagram in FIG. 6. The illustrative computer system is denoted generally by reference numeral 600 and includes a display 602, input devices in the form of keyboard 604A and pointing device 604B, computer 606 and external devices 608. While pointing device 604B is depicted as a mouse, it will be appreciated that other types of pointing device may also be used.

The computer 606 may contain one or more processors or microprocessors, such as a central processing unit (CPU) 610. The CPU 610 performs arithmetic calculations and control functions to execute software stored in an internal memory 612, preferably random access memory (RAM) and/or read only memory (ROM), and possibly additional memory 614. The additional memory 1414 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 614 may be physically internal to the computer 606, or external as shown in FIG. 6.

The computer system 600 may also include other similar means for allowing computer programs or other instructions to be loaded. Such means can include, for example, a communications interface 616 which allows software and data to be transferred between the computer system 600 and external systems and networks. Examples of communications interface 616 can include a modem, a network interface such as an Ethernet card, a wireless communication interface, or a serial or parallel communications port. Software and data transferred via communications interface 616 are in the form of signals which can be electronic, acoustic, electromagnetic, optical or other signals capable of being received by communications interface 616. Multiple interfaces, of course, can be provided on a single computer system 600.

Input and output to and from the computer 606 is administered by the input/output (I/O) interface 618. This I/O interface 618 administers control of the display 602, keyboard 604, external devices 608 and other such components of the computer system 600. The computer 606 also includes a graphical processing unit (GPU) 620. The latter may also be used for computational purposes as an adjunct to, or instead of, the (CPU) 610, for mathematical calculations.

Aspects of the present invention may also be implemented on a distributed system comprising a plurality of individual computer systems.

Embodiments of aspects of the present invention may be implemented entirely in hardware, entirely in software, or by way of a combination of hardware and software. In a preferred embodiment, the invention is implemented in software, which includes but is not limited to firmware, resident software, microcode, and the like. Furthermore, the invention can take the form of a computer program product accessible from a computer usable or computer readable medium providing program code for use by or in connection with a computer or any instruction execution system. In such embodiments, the computer program product may reside on a machine readable storage medium in a computer such as the computer 606, or on a machine readable storage medium external to the computer 606, or on any combination thereof.

It is to be understood that the term “machine readable storage medium” is intended to encompass any apparatus that can contain, store, communicate, transport the program for use by or in connection with the instruction execution system, apparatus, or device. For example, and without limitation, the medium may be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and DVD read/write (DVD-R/W).

One or more currently preferred embodiments have been described by way of example. It will be apparent to persons skilled in the art that a number of variations and modifications can be made without departing from the scope of the invention as defined in the claims.

What is claimed is:

1. A method for receiving and storing data for multiple tenants in a single system, comprising:
maintaining, in a database system executing in memory by a processor of a computer, for a plurality of tenants, a plurality of translation maps, each translation map corresponding to a particular tenant;
receiving, in the database system executing in memory by the processor of the computer, data sets from one of the tenants, each data set comprising a plurality of data elements relating to a client of the one of the tenants;
reorganizing, in a translation process executing in memory by the processor of the computer, the data elements into a common format according to the translation map for the one of the tenants; wherein in the common format, each data element is identified as being one of a core data element and a tenant-related data element;
storing the core data elements in at least one core table in the database system executing in memory by the processor of the computer, the at least one core table accessible by all tenants; and
storing the tenant-related data elements in at least one tenant-specific table in the database system executing in memory by the processor of the computer, the at least one tenant-specific table accessible only by the tenant with whom the tenant-related data elements originated; wherein each data element is uniquely associated with the one of the tenants from which it originated.

2. The method of claim 1, further comprising generating tenant-specific, rule-driven communications to clients of the tenants by applying, in the database system executing in memory by the processor of the computer, communication rules to the data elements wherein the communication rules comprise at least industry-specific communication rules.

3. The method of claim 2, wherein the tenant-related data elements comprise industry-specific data elements and tenant-specific data elements, and wherein in the common format, each data element that is identified as a tenant-related data element is further identified as being one of an industry-specific data element and a tenant-specific data element.

4. The method of claim 2, wherein the industry-specific communication rules comprise generic industry-specific communication rules and tenant-mediated industry-specific communication rules.

5. The method of claim 2, wherein the communication rules further comprise universal communication rules.

6. The method of claim 2, wherein the communication rules further comprise tenant-specific communication rules.

7. A method for initializing a data management system for a plurality of tenants, comprising:
maintaining, in a database system executing in memory by a processor of a computer, a core schema containing common core objects;
maintaining, in the database system executing in memory by the processor of a computer, a plurality of pre-developed industry-specific schema templates in the database system; and
responsive to addition of a new tenant, selecting one of the industry-specific schema templates corresponding to an industry of the new tenant and cloning the selected industry-specific schema template to generate a tenant schema for the new tenant in the database system executing in memory by the processor of the computer.

8. A method for managing tenant-specific, rule-driven communications for a plurality of tenants, comprising:
maintaining, in a database system executing in memory by a processor of a computer, client data relating to clients of a plurality of tenants;
maintaining, in the database system executing in memory by the processor of the computer, a plurality of universal communication rules applicable to all tenants;
maintaining, in the database system executing in memory by the processor of the computer, a plurality of industry-specific communication rules applicable only to tenants within a particular industry; and
for each tenant, generating, in the database system executing in memory by the processor of the computer, communications to clients of that tenant according to the universal communication rules and the industry-specific communication rules applicable to that tenant.

9. The method of claim 8, wherein:
the industry-specific communication rules comprise generic industry-specific communication rules and tenant-mediated industry-specific communication rules dependent on at least one variable determined by the respective tenant.

10. The method of claim 8, further comprising:
maintaining, in the database system executing in memory by the processor of the computer, a plurality of tenant-specific communication rules, each of the tenant-specific communication rules applicable to a specific one of the plurality of tenants; and
for each tenant, generating, in the database system executing in memory by the processor of the computer, communications to clients of that tenant according to the tenant-specific communication rules applicable to that tenant.

11. A computer program product, comprising a machine readable storage medium having a machine readable program code embodied therein, the machine readable program code adapted to be executed to implement a method for receiving and storing data for multiple tenants in a single system, said method comprising:
maintaining, for a plurality of tenants, a plurality of translation maps, each translation map corresponding to a particular tenant;
receiving data sets from one of the tenants, each data set comprising a plurality of data elements relating to a client of the one of the tenants;
reorganizing the data elements into a common format according to the translation map for the one of the tenants; wherein in the common format, each data element is identified as being one of a core data element and a tenant-related data element;
storing the core data elements in at least one core table, the at least one core table accessible by all tenants; and
storing the tenant-related data elements in at least one tenant-specific table, the at least one tenant-specific table accessible only by the tenant with whom the tenant-related data elements originated; wherein each data element is uniquely associated with the one of the tenants from which it originated.

12. The computer program product of claim 11, wherein the method further comprises generating tenant-specific, rule-driven communications to clients of the tenants by applying communication rules to the data elements wherein the communication rules comprise at least industry-specific communication rules.

13. The computer program product of claim 12, wherein the tenant-related data elements comprise industry-specific data elements and tenant-specific data elements, and wherein in the common format, each data element that is identified as a tenant-related data element is further identified as being one of an industry-specific data element and a tenant-specific data element.

14. The computer program product of claim 12, wherein the industry-specific communication rules comprise generic industry-specific communication rules and tenant-mediated industry-specific communication rules.

15. The computer program product of claim 12, wherein the communication rules further comprise universal communication rules.

16. The computer program product of claim 12, wherein the communication rules further comprise tenant-specific communication rules.

17. A computer program product, comprising a machine readable storage medium having a machine readable program code embodied therein, the machine readable program code adapted to be executed to implement a method for initializing a data management system for a plurality of tenants, said method comprising:
maintaining a core schema containing common core objects;
maintaining a plurality of pre-developed industry-specific schema templates in the database system; and
responsive to addition of a new tenant, selecting one of the industry-specific schema templates corresponding to an industry of the new tenant and cloning the selected industry-specific schema template to generate a tenant schema for the new tenant.

18. A computer program product, comprising a machine readable storage medium having a machine readable program code embodied therein, the machine readable program code adapted to be executed to implement a method for managing tenant-specific, rule-driven communications for a plurality of tenants, said method comprising:
maintaining client data relating to clients of a plurality of tenants;
maintaining a plurality of universal communication rules applicable to all tenants;
maintaining a plurality of industry-specific communication rules applicable only to tenants within a particular industry; and
for each tenant, generating communications to clients of that tenant according to the universal communication rules and the industry-specific communication rules applicable to that tenant.

19. The computer program product of claim 18, wherein:
the industry-specific communication rules comprise generic industry-specific communication rules and tenant-mediated industry-specific communication rules dependent on at least one variable determined by the respective tenant.

20. The computer program product of claim 18, wherein the method further comprises:
maintaining a plurality of tenant-specific communication rules, each of the tenant-specific communication rules applicable to a specific one of the plurality of tenants; and
for each tenant, generating communications to clients of that tenant according to the tenant-specific communication rules applicable to that tenant.
